(19) United States
(12) Patent Application Publication
(10) Pub. No.: US 2003/0107429 A1
(43) Pub. Date: Jun. 12, 2003

(54) Current source circuit

(75) Inventor: Tsutomu Kawano, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: MITSUBISHI DENKI KABUSHIKI KAISHA, Tokyo (JP)

(21) Appl. No.: 10/125,409

(22) Filed: Apr. 19, 2002

(30) Foreign Application Priority Data
Dec. 7, 2001 (JP) 2001-374250

(51) Int. Cl. G05F 1/10

(52) U.S. Cl. 327/538

(57) ABSTRACT

The current source circuit generates a reference current by using an external resistor connected between a terminal and ground. This current source circuit comprises a differential amplifier circuit connected at one of input terminals thereof to a reference power source and connected at the other input terminal thereof to the terminal, a first PNP transistor connected at its base to one of output terminals of the differential amplifier circuit and connected at its collector to the terminal, and a second PNP transistor which is connected at its base to the base of the first PNP transistor and which outputs a reference current from its collector.

### FIELD OF THE INVENTION

The present invention relates to a current source circuit. More particularly, this invention relates to a current source circuit suitable for use as a current source immune to variations in resistance values, temperature characteristics, and so on in a semiconductor integrated circuit.

### BACKGROUND OF THE INVENTION

In the case where a semiconductor integrated circuit needs a current source immune to variations of resistance values, temperature characteristics, and so on in the integrated circuit, a current source circuit is provided. This current source circuit applies a voltage to an external resistor installed between a terminal for the external resistor and the ground to generate a reference current. According to this configuration, a desired characteristic can be obtained by using a resistor having favorable precision and a favorable thermal characteristic as the external resistor. Further, the reference current can be controlled from the outside by changing the resistance.

FIG. 3 shows a configuration example of a conventional current source circuit. In FIG. 3, a PNP transistor 301 and a diode-connected PNP transistor 302 are connected in common at their emitters to a power source 303 and connected in common at their bases to an NPN transistor 304 at its collector. The PNP transistor 301 and the PNP transistor 302 form a current mirror circuit which serves as a load circuit of the NPN transistor 304.

A reference power source (voltage V) 305 is connected to one of input terminal of an operational amplifier 306. An output terminal of the operational amplifier 306 is connected to the NPN transistor 304 at its base. The NPN transistor 304 is connected at its emitter to the other input terminal of the operational amplifier 306 and an external terminal 307. An external resistor 308 is installed between the terminal 307 and ground. The reference power source 305, the operational amplifier 306, and the NPN transistor 304 form a voltage follower of full feedback type.

FIG. 4 shows a specific configuration example of the reference power source 305. FIG. 4A shows a circuit example in which a voltage divider circuit including resistors 402 and 403 is provided between a power source 401 and the ground and a divided voltage V generated by the resistors 402 and 403 is used as the reference voltage V. The reference voltage V obtained in the circuit shown in FIG. 4A varies according to the change of the voltage of the power source 401.

FIG. 4B shows a circuit example in which a plurality of diodes 404 are stacked from the ground side and connected to a power source 406 via a resistor 405 and a drop voltage V across the plurality of diodes 404 is used as the reference voltage V. The reference voltage V obtained in the circuit shown in FIG. 4B is not so influenced by a variation of the voltage of the power source 406. Since the diodes 404 have a temperature characteristic, however, the reference voltage V varies according to the temperature change.

Operation of the circuit shown in FIG. 3 will now be explained. The voltage follower of full feedback type formed of the reference power source 305, the operational amplifier 306, and the NPN transistor 304 conveys the reference voltage V of the reference power source 305 to the emitter of the NPN transistor 304 without an offset. In other words, the reference voltage V of the reference power source 305 is applied to the terminal 307 without any change.

Therefore, a reference current having a value of (terminal voltage at the terminal 307)/(resistance of the external resistor 308) flows through the emitter of the NPN transistor 304. This reference current is nearly equal to a current which flows through the collector of the NPN transistor 304. Therefore, in the current mirror circuit which is the load circuit of the NPN transistor 304, a reference current I indicated by an arrow directed from the emitter of the PNP transistor 301 toward the ground is obtained. This reference current I is used as a constant current source in amplifier circuits and other circuits within the semiconductor integrated circuit.

If the resistance of the external resistor 308 is constant, the reference current I fully depends on the terminal voltage of the terminal 307=the reference voltage V. In other words, a constant current is always obtained in the circuit shown in FIG. 3 when the reference voltage V and the resistance of the external resistor 308 do not depend on the temperature and vary little.

In the terminal 307 provided in the semiconductor integrated circuit, however, stray (parasitic) capacitance generally exists, more or less. Since the emitter of the NPN transistor 304 is connected directly to the terminal 307 in the circuit shown in FIG. 3, stray capacitance exists with respect to the ground in some cases. As a result, the following problem occurs in the circuit shown in FIG. 3. The problem will now be explained by referring to FIG. 5.

FIG. 5 shows an equivalent circuit in the case where stray capacitance exists. As shown in FIG. 5, the reference power source 305 is directly connected to the base of the NPN transistor 304. The collector of the NPN transistor 304 is connected to the power source 303 via a resistor 501. And stray capacitance 502 is connected in parallel with the external resistor 308.

In other words, FIG. 5 shows that the circuit shown in FIG. 3 is equivalent to a grounded-emitter amplifier. This circuit has a characteristic in which the gain rises as impedance between the emitter of the NPN transistor 304 and the ground becomes lower. If the stray capacitance 502 exists between the emitter of the NPN transistor 304 and the ground, then, the impedance of the stray capacitance 502 drops and the gain rises as the frequency becomes higher.

On the other hand, noise containing various components exists in the base of the NPN transistor 304. The NPN transistor 304 itself produces noise. If the stray capacitance 502 exists, then, there occurs a phenomenon in which species of high frequency noise components increase. This results in a problem that a signal-to-noise ratio (S/N) of the handled signal is aggravated if the collector current (reference current I) of the NPN transistor 304 is used as a reference current of an amplifier circuit or the like.

Conventionally, therefore, a current source circuit shown in, for example, FIG. 6 is used to reduce the degradation of the S/N ratio. As shown in FIG. 6, the improved current source circuit has a resistor element 601 having small resistance inserted between the emitter of the NPN transistor 304 and the terminal 307 in the configuration shown in FIG. 3.

According to this configuration, the emitter of the NPN transistor 304 is not connected directly to the terminal 307 owing to the interposition of the resistor element 601. Therefore, the impedance measured from the emitter is prevented from being extremely lowered. As a result, degradation of the S/N ratio is prevented.

In the improved current source circuit shown in FIG. 6, however, the resistor element 601 interposed for the purpose of preventing the S/N ratio degradation is a component of the current source circuit incorporated in the semiconductor integrated circuit. If the value of the resistor element 601 varies due to the temperature or dispersion in manufacturing, then, its influence appears in the reference current I as it is. Therefore, the resistance of the resistor element 601 must be decreased than that of the external resistor 308. However, this results in a problem that the S/N ratio degradation preventing effect is lowered as the resistance of the resistor element 601 is decreased.

### SUMMARY OF THE INVENTION

It is an object of the present invention to provide a current source circuit which has a favorable S/N ratio and depends on only the external resistor.

The current source circuit according to this invention generates a reference current by using an external resistor connected between an external terminal and ground. The current source circuit comprises a differential amplifier circuit whose one of the input terminals is connected to a reference power source and the other input terminal is connected to the external terminal. This current source circuit also comprises a first transistor whose control terminal is connected to one of the output terminals of the differential amplifier circuit and whose output terminal is connected to the external terminal, and a second transistor whose control terminal is connected to the control terminal of the first transistor, and which outputs a reference current from an output terminal thereof.

According to the above-mentioned aspect, the one input terminal of the differential amplifier circuit is supplied with a reference voltage from the reference power source, and consequently it is a positive input terminal. Therefore, the other input terminal is a negative input terminal. The output of the first transistor which takes out the output of the differential amplifier circuit is a positive-phase output, but this output is applied to the negative input terminal of the differential amplifier circuit. Accordingly, an operational amplifier of full feedback is formed, and the potential of the negative input terminal of the differential amplifier circuit becomes equal to the reference voltage. Since the reference voltage is applied to the external resistor connected to the external terminal, a current depending upon the resistance of the external resistor flows through the output terminal of the first transistor. As a result, the current depending upon the resistance of the external resistor also flows through the output terminal of the second transistor connected in parallel with the first transistor.

Moreover, all of the current source circuits are formed of bipolar transistors or MOS transistors.

Furthermore, at least differential pair transistors in the differential amplifier circuit are formed of NMOS transistors. Therefore, it becomes unnecessary to consider an influence of the base current, which is necessary when all of the differential amplifier circuits are formed of bipolar transistors.

Moreover, oscillation is prevented by the capacitance element provided between the line, which couples the control terminals of the first transistor and the second transistor to the output terminal of the differential amplifier circuit, and the power source line.

Other objects and features of this invention will become apparent from the following description with reference to the accompanying drawings.

### BRIEF DESCRIPTION OF THE DRAWINGS

FIG. 1 is a circuit diagram showing a configuration of a current source circuit which is a first embodiment of the present invention,

FIG. 2 is a circuit diagram showing a configuration of a current source circuit which is a second embodiment of the present invention,

FIG. 3 is a configuration example of a conventional current source circuit,

FIG. 4 is a diagram showing a specific configuration example of a reference source shown in FIG. 3,

FIG. 5 is a diagram showing an equivalent circuit in the case where stray capacitance exists, and

FIG. 6 is a diagram showing a configuration example of an improved conventional current source circuit.

### DETAILED DESCRIPTIONS

Embodiments of the current source circuit according to the present invention will be described in detail by referring to the accompanying drawings.

FIG. 1 is a circuit diagram showing a configuration of a current source circuit which is a first embodiment of the present invention. In FIG. 1, a PNP transistor 101 and a diode-connected PNP transistor 102 are connected in common at their emitters to a power source 103 and connected in common at their bases to an NPN transistor 104 at its collector. The PNP transistor 101 is connected at its collector to an NPN transistor 105 at its collector. The NPN transistor 104 and the NPN transistor 105 are grounded in common at their emitters via a constant current source 106.

The NPN transistor 104 and the NPN transistor 105 form a differential pair. The PNP transistor 101 and the diode-connected PNP transistor 102 form a current mirror circuit which serves as one of load circuits of the NPN transistors 104 and 105 of the differential pair. The whole including the constant current source 106 forms a differential amplifier circuit. A reference power source (voltage V1) 107 is connected to the NPN transistor 105 at its base which is one of input terminals of the differential amplifier circuit. A PNP transistor 108 is connected at its collector to the NPN transistor 104 at its base which is the other input terminal of the differential amplifier circuit. An external terminal 109 is also connected to the base of the NPN transistor 104.

The PNP transistor 108 is connected at its emitter to the power source 103 via a resistor element 110. The PNP transistor 108 and a PNP transistor 111 are connected at their bases to the collector of the PNP transistor 101. The PNP transistor 111 is connected at its emitter to the power source 103 via a resister element 112. The PNP transistor 108 and the PNP transistor 111 form another load circuit of the NPN transistors 104 and 105 of the differential pair. An external resistor 113 is connected between the terminal 109 and the ground. A capacitance element 114 explained below is provided to prevent oscillation. That is, this capacitance element 114 is connected between a line, which connects the bases of the PNP transistors 108 and 111 to the collector of the PNP transistor 101, and the power source 103.

Operation of the current source circuit according to the first embodiment will now be described by referring to FIG. 1. The base of the PNP transistor 108 is connected to the collector of the NPN transistor 105. If the voltage of the reference power source 107 is applied to the base of the NPN transistor 105 and the NPN transistor 105 turns on, then the PNP transistor 108 also turns on. Assuming that the base of the NPN transistor 105 is a positive input, the collector output of the PNP transistor 108 is a positive-phase output. The collector output of the PNP transistor 108 is applied to the base (negative input) of the NPN transistor 104 and the external resistor 113 connected to the terminal 109. As a result, the base potential of the NPN transistor 104 becomes equal to the voltage of the reference power source 107. In other words, an operational amplifier of full feedback type is formed.

Denoting the voltage of the reference power source 107 by V1, a base current of the NPN transistor 104 by Ib4, and the resistance of the external resistor 113 by R, a collector current Ic8 of the PNP transistor 108 is represented by the following equation.

Ic8=(V1/R)+Ib4 (1)

Denoting a base current of the PNP transistor 108 by Ib8, an emitter current Ie8 of the PNP transistor 108 is represented by the following equation.

Ie8=Ic8+Ib8=(V1/R)+Ib4+Ib8 (2)

If the resistor element 110 and the resistor element 112 are equal in resistance and the PNP transistor 108 and the PNP transistor 111 are equal in size, an emitter current Ie11 of the PNP transistor 111 is represented by the following equation.

Ie11=Ie8=(V1/R)+Ib4+Ib8 (3)

Denoting a base current of the PNP transistor 111 by Ib11, a collector current Ic11 of the PNP transistor 111 is represented by the following equation.

Ic11=Ie11−Ib11 (4)

Since the resistor element 110 and the resistor element 112 are equal in resistance and the PNP transistor 108 and the PNP transistor 111 are equal in size, it can be said that Ib11=Ib8. Therefore, the collector current Ic11 of the PNP transistor 111 is represented by the following equation.

Ic11=(V1/R)+Ib4+Ib8−Ib11=(V1/R)+Ib4 (5)

The collector current Ic11 of the PNP transistor 111 gives the reference current I. If the current of (V1/R) in the equation (5) is sufficiently larger than the base current Ib4 and the base current Ib4 is negligible, then the collector current Ic11 of the PNP transistor 111 becomes a current determined by the reference voltage V1 of the reference power source 107 and the resistance R of the external resistor 113.

Thus, according to the first embodiment, the current source which depends on only the resistance R of the external resistor 113 can be formed in the semiconductor integrated circuit. In addition, the emitter of the PNP transistor 108 is not connected directly to the terminal 109. Therefore, the current source circuit in which the S/N ratio is not degraded can be obtained even if stray capacitance exists between the terminal 109 and the ground.

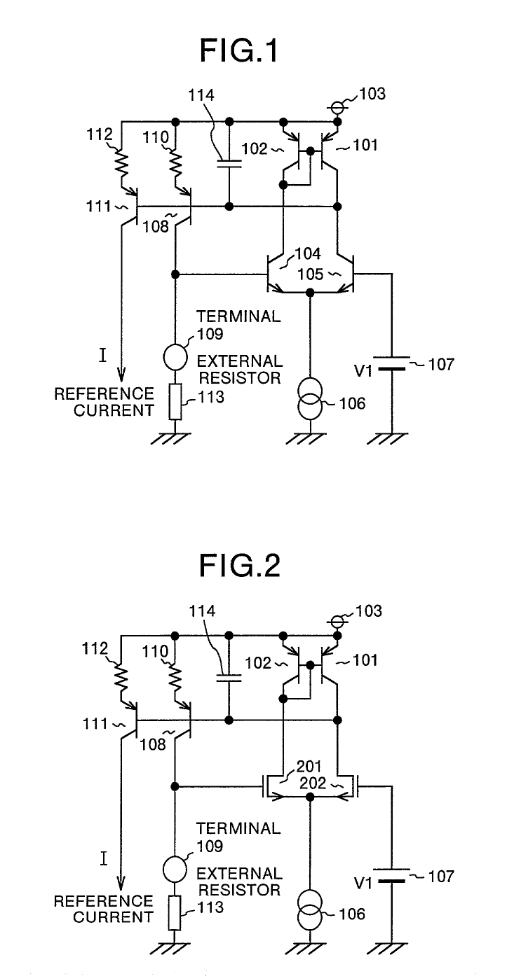

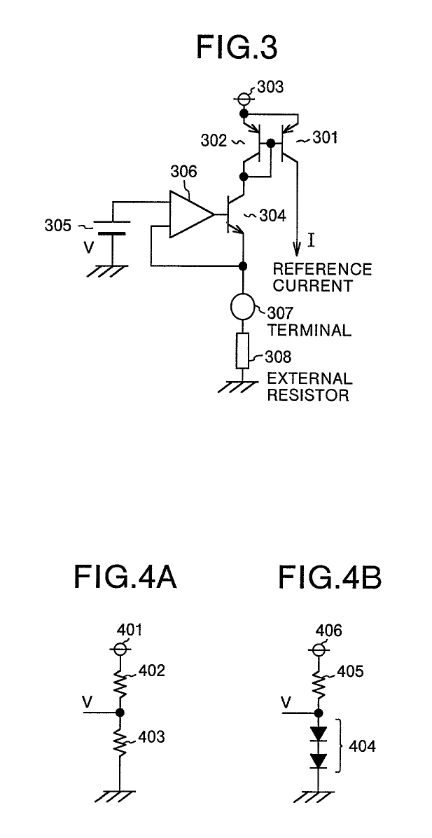

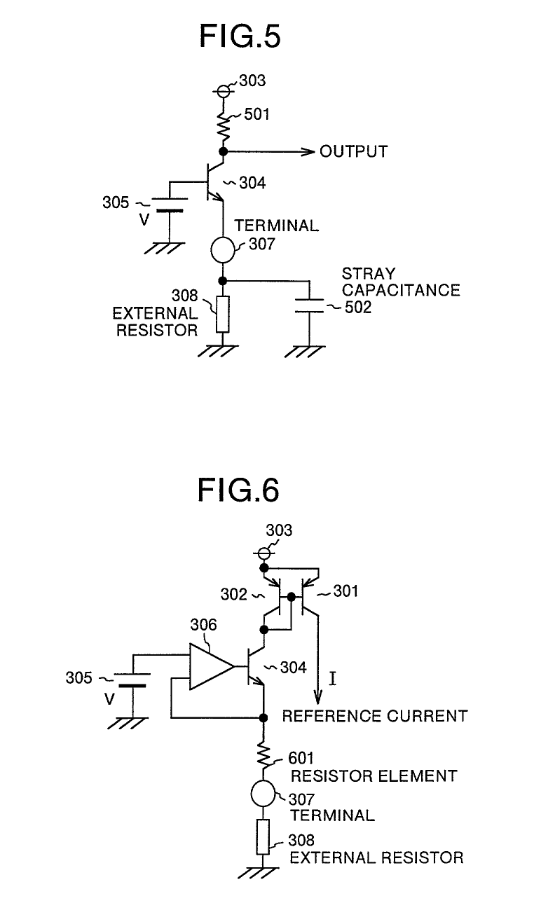

FIG. 2 is a circuit diagram showing a configuration of a current source circuit which is a second embodiment of the present invention. In the second embodiment, a configuration example using MOS transistors is shown. As shown in FIG. 2, the NPN transistors 104 and 105 of a differential pair in the configuration of FIG. 1 are replaced by NMOS transistors 201 and 202 of the differential pair. Other components are the same as those of the configuration shown in FIG. 1. The configuration will be described centering a portion which concerns the second embodiment.

According to this configuration, base currents in the bipolar transistors do not exist in the MOS transistors. Therefore, the base current Ib4 which exists in the equation (5) disappears and the collector current Ic11 of the PNP transistor 111 is represented by the following equation.

Ic11=(V1/R)+Ib4+Ib8=(V1/R) (6)

Thus, according to the second embodiment, a reference current I is obtained. More specifically, the referent current I is determined perfectly by the reference voltage V1 of the reference power source 107 and the resistance R of the external resistor 113. The second embodiment provides a case in which as elements directly concerning the present invention only the differential pair transistors are implemented by MOS transistors. However, all the bipolar transistors shown in FIG. 1 may be replaced by MOS transistors.

According to this invention, the one input terminal of the differential amplifier circuit is supplied with a reference voltage from the reference power source, and consequently it is a positive input terminal. Therefore, the other input terminal is a negative input terminal. The output of the first transistor which takes out the output of the differential amplifier circuit is a positive-phase output, but this positive-phase output is applied to the negative input terminal of the differential amplifier circuit. Accordingly, an operational amplifier of full feedback type is formed, and the potential of the negative input terminal of the differential amplifier circuit becomes equal to the reference voltage. Since the reference voltage is applied to the external resistor connected to the external terminal, a current depending upon the resistance of the external resistor flows through the output terminal of the first transistor. As a result, a current depending upon the resistance of the external resistor also flows through the output terminal of the second transistor connected in parallel with the first transistor. Accordingly, a reference current determined by the reference voltage and the resistance of the external resistor is obtained. In addition, since the input terminal of the first transistor is not connected to the external terminal, the S/N ratio is prevented from being degraded.

Moreover, all of the current source circuit can be formed of bipolar transistors or MOS transistors.

Furthermore, at least differential pair transistors in the differential amplifier circuit are formed of NMOS transistors. Therefore, it becomes unnecessary to consider an influence of the base current, which is necessary when all of the differential amplifier circuits are formed of bipolar transistors. Therefore, a reference current which is determined completely by the reference voltage and the resistance of the external resistor is obtained.

Moreover, oscillation is prevented by the capacitance element provided between the line, which couples the control terminals of the first transistor and the second transistor to the output terminal of the differential amplifier circuit, and the power source line. Therefore, a stable current source circuit is obtained.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A current source circuit which generates a reference current by using an external resistor connected between an external terminal and ground, said current source circuit comprising:
a differential amplifier circuit which is connected at one of input terminals thereof to a reference power source and is connected at the other input terminal thereof to said external terminal;
a first transistor which is connected at a control terminal thereof to one of output terminals of said differential amplifier circuit and is connected at an output terminal thereof to said external terminal; and
a second transistor which is connected at a control terminal thereof to the control terminal of said first transistor and which outputs a reference current from an output terminal thereof.

2. The current source circuit according to claim 1, wherein said differential amplifier circuit, said first transistor and said second transistor are formed of bipolar transistors or MOS transistors.

3. The current source circuit according to claim 1, wherein said first transistor and said second transistor are formed of PNP transistors, and at least differential pair transistors in said differential amplifier circuit are formed of NMOS transistors.

4. The current source circuit according to claim 1, wherein a capacitance element to prevent oscillation is connected between a line, which couples the control terminals of said first transistor and said second transistor to the output terminal of said differential amplifier circuit, and a power source line.
